(19) United States
(12) Patent Application Publication
(10) Pub. No.: US 2002/0038267 A1
(43) Pub. Date: Mar. 28, 2002

(54) System and method for using radio frequency identification in retail operations

(76) Inventors: Necmettin Can, Crescent Springs, KY (US); Charles K. Crovitz, Orinda, CA (US); Debbi M. Turner, Springdale, AK (US); Rayford K. Whitley, San Francisco, CA (US)

Correspondence Address: MICHAEL D. BEDNAREK, SHAW PITTMAN LLP, 1650 TYSONS BOULEVARD, MCLEAN, VA, 22102, US

(21) Appl. No.: 09/944,383

(22) Filed: Sep. 4, 2001

Related U.S. Application Data
(60) Provisional application No. 60/229,599, filed on Sep. 5, 2000.

(51) Int. Cl. G06F 17/60

(52) U.S. Cl. 705/28

(57) ABSTRACT

A system and method for conveniently tracking inventory and merchandise in a retail setting is disclosed. The system can track various items as they travel through the entire supply chain. The system includes provisions that provide accurate and real time information related to available inventory on retail floor space and in storage. The system can be used to automatically determine available inventory and the system can be used to assist customers and staff in locating particular items.

This application claims the benefit of U.S. Provisional Application No. 60/ 229,599 filed Sep. 5, 2000, which is herein incorporated by reference in its entirety.

### BACKGROUND

1. Field of the Invention

The present invention relates to the use of radio frequency identification (RFID) in retail operations. In particular, the present invention relates to systems and methods for using RFID to facilitate a variety of processes within the supply chain of a retail organization.

2. Background of the Invention

Radio frequency identification (RFID) is a technology that uses radio frequency waves to transfer data between a reader and a moveable item. FIG. 1 shows a high level view of an RFID system that includes a tag, an antenna, a reader and a host computer. As shown, the antenna captures the tag ID number, the reader then interprets the radio frequency into digital information and the host is a software database.

In RFID systems, the type of tag used can vary greatly. The tag may be read-only or read/write capable. The tag preferably has an anti-collision characteristic to provide the ability to read/write one or many tags at a time. The tag may vary in size from a thumbnail (or even smaller) to the size of a brick. The price of individual tags may also vary greatly currently in a range from $0.30 to $250.00 per tag. Naturally, as technology develops, new characteristics are added and the price decreases.

RFID technology offers advantages over other systems, such as bar coding. To begin with, RFID technology is contactless (non-contact) and is not dependent on line of sight. Moreover, RFID technology is effective in visually and environmentally challenging conditions where barcode or other optically-read technologies would be useless. In addition, RFID technology offers fast read speed, in most instances responding in less than 100 milliseconds using current technology. RFID technology also offers extremely high data accuracy and makes it possible to provide read/write capability for interactive applications.

Currently, RFID technology is used to tag pallets or cartons; vehicles; company assets; items such as apparel, luggage and laundry; people, livestock or pets; and high-value electronics such as computers and TVs. Current applications for RFID technology include security access; loss prevention; asset and inventory tracking; automatic toll collection; wildlife and livestock tracking; house arrest monitoring systems; manufacturing work in process data; shipping and intermodal containers and air cargo tracking; trailer maintenance; and railroad car tracking.

Although various proposals for using RFID technology have been put forward and attempted, there remains a need for a system and method for using RFID technology to optimize the supply chain and operations of a retail organization. Moreover, as improvements in RFID technology and components occur, there will be greater opportunities to optimize supply chains of all types, particularly those of retail organization.

### SUMMARY OF THE INVENTION

The present invention provides a system and method for using RFID technology in a supply chain to provide advantages in each stage of the supply chain. The system is particularly useful in the context of improving operations and efficiency in a retail organization. One example of a retail organization that can benefit from the present invention is a retailer of ready-to-wear garments and accessories, including jewelry, eyewear, personal care and home products, baby products and toys. The invention is, however, useful in other environments as well.

The supply chain for a typical retail organization includes various stages, such as factories for producing products, a freight forwarding/consolidator, a de-consolidator, distribution centers, poolers and stores or retail outlets. As used herein, the term “consolidator” refers to a facility (often a third party facility) that the manufacturers ship the product to. The product is “consolidated” at this point into containers or “loads” for shipping purposes. “De-consolidator”—refers to a facility (often a third party facility) that the product is centrally received at. The product is then sorted into shipments (trailers) that are sent to the respective distribution centers. “Pooler” refers to a facility (often a third party facility) that receives trailer shipments of product from the distribution center then in turn breaks out the shipments into store delivery shipments, and delivers the goods to the store. “SCaN,” in the context of shipment tracking refers to a system used to track and monitor the carton level movement of product within the supply chain. “SuperRat” refers to touch screen monitors used as the touch screen manual receiving stations that are used in the present invention. The present invention is applicable, but not limited to, retail organizations and non-retail organizations having this type of supply chain.

In accordance with the system and method of the present invention, an RFID tag is associated with each item (or carton or person) to be tracked. In a retail organization that sells ready-to-wear garments, for example, an RFID tag is associated with each ready-to-wear garment. The tag may be sewn into the garment and/or placed into a tag that is attached after the garment is manufactured.

The system and method of the present invention can use the various forms of RFID technology currently available for using radio frequency waves to transfer data between a reader and a moveable item. Since the technology relating to RFID is changing rapidly, the techniques, processes and systems described herein are not limited to any particular RFID technology, but preferably use state of the art RFID technology to obtain the greatest cost/benefit for a particular application or set of applications.

In addition to tags, the system further comprises a plurality of tag readers at locations throughout the supply chain. As used herein, “tag reader” is also intended to encompass devices for writing data onto tags that have a read/write capability. The “tag readers” preferably include both an antenna for capturing signals from the tags and a “reader” that interprets the radio frequency into digital information. The “tag reader” should also include a transmitter if the tag reader is to be used to write data onto the tags. The tag readers preferably come in various forms to accommodate the particular need. For example, fixed tag readers along a conveyor belt or tunnel may be provided at a loading dock or distribution center, while hand held tag readers may be provided to associates at stores or distribution centers.

The system also includes at least one and typically a plurality of host computers for receiving and processing information from the tag readers and interfacing with other inventory, operations and logistics systems. If the tag readers are designed to provide information in digital form, then the host computer(s) receive and process the information in this form. Naturally, the conversion to digital form could take place in the host computer, if desired.

The use of RFID technology yields savings throughout the retail supply chain, including increased recovery of vendor quality chargebacks; a reduction of freight loss; increased accuracy of store receiving; increased data integrity of store inventory management; a reduction of store backroom lost sales; increased efficiency and effectiveness of store loss prevention activities; increased data integrity of merchandise returns; enhanced vendor shortship visibility; improved distribution center picking/stocking labor efficiency, and improved distribution center inventory accuracy. The use of RFID technology also makes it possible to improve loss prevention procedures at each step in the supply chain.

The following paragraphs provide an overview of applications of RFID technology to retail operations and supply chains to enhance operational efficiency and provide a comprehensive systematic loss prevention program.

Vendor Quality Chargebacks/Inventory Accuracy

The system and method of the present invention applies RFID to enable the Retailer (e.g., ready-to-wear apparel and accessory retailer) to identify which manufacturers are producing products of poor quality. Assuming that the RFID tag is associated with the item, in one example where the item is a garment, the RFID tag could be sewn into the garment and the vendor/manufacturer is identified in the RFID memory, the Retailer would have the ability to take customer returns due to poor quality and trace the unit back to the vendor/manufacturer. Thus, this system facilitates the Retailer's efforts to seek recompense from the vendor. Furthermore, the Retailer could implement process changes or stop purchasing from that particular manufacturer until product quality and quality control has been improved and confirmed.

Freight Loss

The Retailer typically loses an opportunity to recoup freight losses during transit. Scanning the RFID tagged units before delivering to the poolers and during the store delivery process will enable the Retailer (e.g., ready-to-wear retailer) to identify any discrepancies and provide the documentation to support freight claims. Loss prevention is improved when discrepancies can be quickly detected and traced to one participant in the supply chain, e.g., the shipper.

Store Receiving

In this area a portion of the potential savings comes from reducing labor costs incurred during the receiving process. However, the largest percentage of the benefits comes from recouping lost margin dollars resulting from inaccurate receiving data. Store inventory management RFID technology can be applied to facilitate inventory physical counts at the stores. A Retailer (e.g., ready-to-wear retailer) currently spends money either directly or by hiring 3^{rd} party companies to come into stores and perform physical counts. This annual cost increases as the Retailer expands its store base.

Furthermore, field staff time spent on taking regular and ad hoc physical counts can be reduced significantly or eliminated through RFID. A benefit that is difficult to quantify is the ability of merchandise planning and distribution groups to make better decisions because they would base their decisions on more accurate inventory data. In addition, loss prevention is improved because it is possible to track products.

Store Loss Prevention

RFID technology can potentially replace sensor tag technology in the stores to prevent both customer theft and employee theft. One example of a sensor tag that is used to assist with inventory control is a SENSORMATIC tag. The sensor tag solution is expensive for two reasons: the cost of the sensor tags and the store labor required to affix the tags. If RFID tags are embedded or affixed at the manufacturer, the cost of the sensor tags and the associated store labor costs are eliminated. Another problem with sensor tags is the difficulty of removing those tags after the item has been purchased. In some instances, salespersons inadvertently forget to remove sensor tags after an item has been purchased. Consumers who have purchased items with sensor tags that have not been removed experience considerable difficulty in removing those tags themselves. Occasionally, the process of removing the sensor tag damages or destroys the item attached to the tag. Customer could also return the item to the store to have a salesperson remove the sensor tag, but that is generally inconvenient. Use of RFID tags would eliminate this difficult and hazardous removal process and would also eliminate the need for customers to return items for sensor tag removal.

In addition, RFID technology is especially useful in preventing employee theft since it is possible to maintain records as to the identity of a person deactivating or flagging an RFID tag. If a tag is deactivated or flagged and the product is later determined to be missing, i.e., not sold or not in inventory, the identity of the person that deactivated or flagged the tag can be useful in preventing loss.

Point-of-Sale Data Integrity

This type of data integrity occurs when a store associate keys in an undeterminable number because the item SKU cannot be identified. When this occurs, on-hand inventory is not decremented resulting in poor data integrity and sales loss. RFID technology can mitigate this problem by having the item identified by the RFID chip, which can be read by an interrogator connected to or a part of the point-of-sale system.

Store Backroom

When merchandise is not on the sales floor, but sitting in the backroom, there is a potential for lost sales. One potential remedy for this issue is to reduce the backroom space to force the backstock on to the sales floor. Another remedy would be to use RFID technology to scan the backroom whenever an item is not in stock on the sales floor. If the item is in the backroom, it will be located through RFID, retrieved and moved to the sales floor or provided to the customer. This process could be automated by running periodic comparisons of inventory data reflecting products on the sales floor and data reflecting products in storage.

Merchandise Returns Data Integrity Problems

This type of data integrity problem results from sales associates incorrectly keying in the style number of returned merchandise without a ticket or a receipt. Again, this problem can be addressed by the RFID chip, which can be read by an interrogator connected to or a part of the point-of-sale system.

Vendor Shortship Visibility

Currently, Retailers do not have visibility to their goods at the SKU level as they leave the factory. RFID technology embedded in the clothing combined with appropriately placed RFID interrogators will give the Retailer (e.g., ready-to-wear retailer) visibility at the unit level to what each vendor is delivering. This application of RFID results in more accurate inventory control and payment on goods actually received.

Picking/Stocking Labor Savings at the Distribution Center

Labor savings would result from the elimination of the visual and/or line of sight SKU verification process that is currently required with the current picking and stocking processes. In addition, RFID would provide the Retailer the capability to re-engineer the current picking and stocking processes, examples being: batch picking of units to the sorter without individual store separation, reduced manual pick, adjusted capacities, increased capital utilization, etc. “Batch pick” refers to the picking of demand allocation for all stores within the same timeframe. The use of RFID at this stage of the supply chain is also useful in loss prevention.

Inventory and Accuracy

Annual labor savings by eliminating or reducing inventory adjustments and automating picking accuracy audits are significant. While RFID would reduce the cost associated with accuracy, it would also increase the amount of cartons verified from random sampling to 100%.

Fitting Room Data Collection

RFID technology can be used to track the fitting room traffic. To facilitate this feature, antennas are placed at the entrance of fitting rooms to read the tags of garments that are brought into the fitting room. Data concerning the identity of products taken into the fitting rooms is gathered as indicia of consumer interest in the garment. The system preferably includes software for correlating the fitting room data with other data, such as sales data or shelf location data, to provide business information and market research tools by, for example, identifying products that are frequently tried on, but seldom purchased, or showing the relationship between the frequency with which a garment is tried on and the garment's location within the store.

Other

There are additional potential applications that result from ubiquitous use of RFID technology according to the present invention. These include: store asset management; tracking of customer shopping behavior within the store; visibility to fitting room conversion; trademark infringement and anti-counterfeiting; sample tracking and management; and consolidators, poolers, and the ability to monitor the capacity at various distribution facilities. The sample tracking and management can refer to internal sample tracking. For example, prototypes used for design, merchandising and production purposes can be lost, misplaced, or difficult to locate in design, merchandising and production offices, or in the transfer among those offices. The present invention would permit a company to track a prototype or sample that has been shipped or located internally. The system would also permit a company to track other inter-office shipments.

Summary

Thus, it should be apparent that as applied in the system and method of the present invention, RFID technology will allow unit level visibility within the Retailer's supply chain. This type of visibility will allow the Retailer to bring together the supply chain links to form a whole and enable the Retailer to achieve pipeline excellence. In addition, RFID will provide unit level visibility within the store environment allowing the Retailer to provide increased levels of customer service. Finally, the ubiquitous use of RFID enhances loss prevention throughout the supply chain as demonstrated by the foregoing examples.

### BRIEF DESCRIPTION OF THE DRAWINGS

FIG. 1 is a high level view of a preferred embodiment of an RFID system that includes a tag, an antenna, a reader and a host computer.

FIG. 2 is a schematic representation of a preferred embodiment of a retail organization's six-stage supply chain.

FIG. 3 is an exploded view of a preferred embodiment of an example of a RFID tag used in the system and method of the present invention.

FIG. 4 is an isometric view of a preferred embodiment of a portable dock loader in accordance with the present invention.

FIG. 5 is a schematic view of a preferred embodiment of a conveyor assembly in accordance with the present invention.

FIG. 6 is a front view of a preferred embodiment of a fixture in accordance with the present invention.

FIG. 7 is a front view of a preferred embodiment of a wireless device in accordance with the present invention.

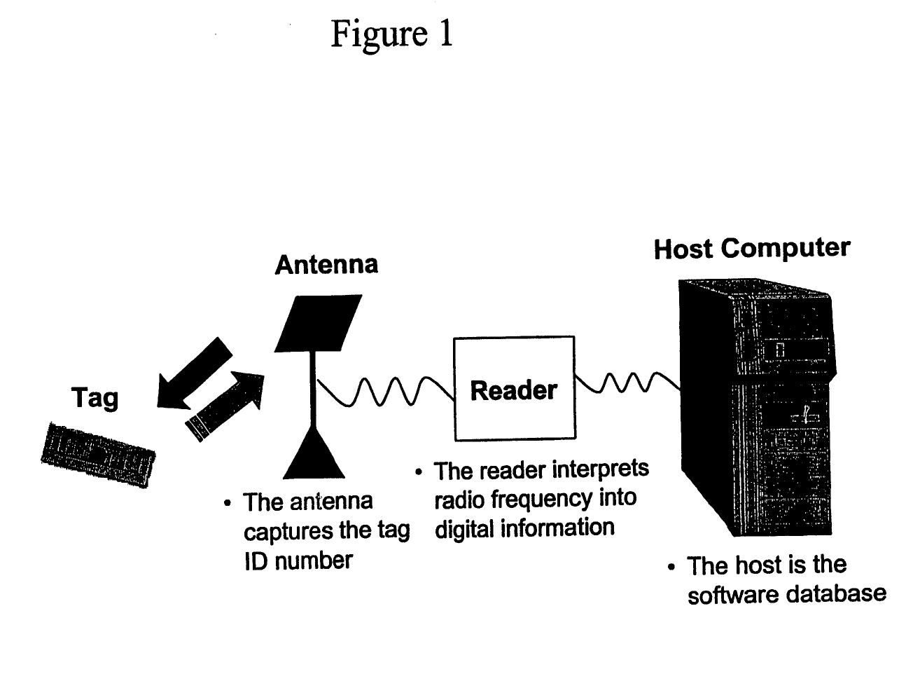

### DETAILED DESCRIPTION OF THE INVENTION

The present invention provides a system and method for using RFID to optimize supply chains and improve retail operations, more particularly the supply chain and operations of a retail organization. The invention is also useful in preventing loss from theft by employees, customers and others.

As used herein, RFID refers to an automatic identification technology that uses radio frequency waves to transfer data between a reader and a tag. As the tag enters the Radio Frequency (RF) field, the RF signal powers the tag, or turns it on.

The tag then transmits the ID and data that has been programmed to the reader. RFID tag readers (Interrogators) translate the radio frequency information into digital information that can be read by software on the host computer. The computer determines the required actions and instructs the reader, which in turn transmits data back to the tag.

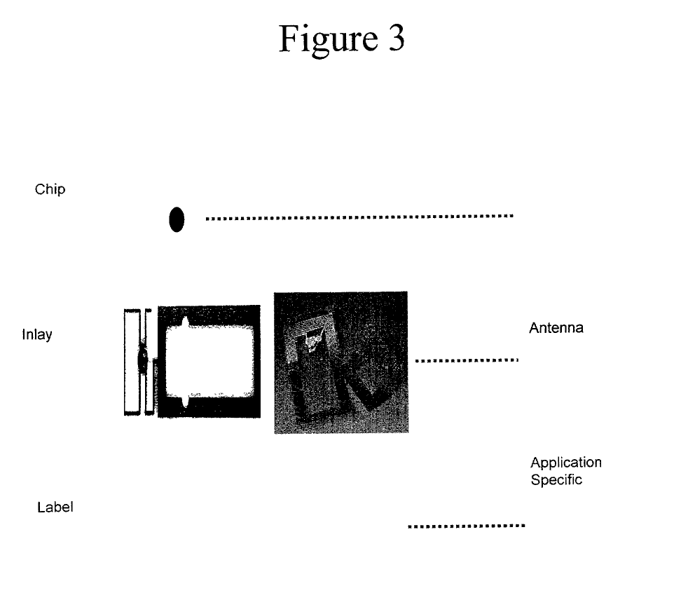

RFID interrogators (or tag readers) are available in many sizes and shapes including portable units. All interrogators have the same basic architecture: antenna, decoder, data converter, computer interface, and a power supply. The tag, which varies in size and appearance, is composed of: a chip, which houses the “intelligence” and contains a unique identifier number (similar to a license plate) to enable tracking; an inlay which is the antenna, encoded within the chip to enable tracking, and the label or other tag or packaging, which is the visual packaging of the components. An example of one tag is shown in FIG. 3.

The RFID tag may be attached to the units at origin. As the units pass interrogators installed in appropriate locations within the retail industry supply chain, RFID technology, when fully developed, can provide SKU level visibility to inventory as it moves through every process. Moreover, RFID offers read/write capability so users can add data to the tags as they pass by an interrogator, enabling functions like time stamping. RFID does not depend on orientation or line-of-sight; in other words RFID tags can be read through a carton. In addition, RFID can identify multiple articles simultaneously.

The RFID tag can be read-only or read/write. Read only tags are historically less expensive than read/write tags. However, a read-only solution would potentially require substantial processing on the backend as enormous databases would be required to store data related to every move of each RFID tagged unit. The RFID tag read/write distances vary depending on tag and antenna size, design and operating frequency.

Depending on the tag construction, an RFID system can operate in harsh industrial or commercial environments with operating temperatures in the range of −25C to +85C. The system can operate at various frequencies. The currently preferred frequencies are 13.56 MHz, 915 MHz, and 2.45 GHz. There are tradeoffs associated with these frequencies. With regard to data reading range, a 13.56 MHz system has a range of 0.25 to 0.5 meters, a 915 MHz system has a range of 3 to 5 meters, and a 2.45 GHz system has a range of 0.5 to 1.0 meters. The actual ranges depend on the particular transponder used, antenna size, number of antennas and the like. Also, the range for writing data is typically about 50% of the read data range. There are also different regulations throughout the world, for example 13.56 MHz systems are not permitted in Japan and 915 MHz are not permitted in Europe. As indicated above, currently both the 13.56 MHz and the 2.45 GHz have relatively weak read/write ranges. The 915 MHz frequency has a more attractive range but is limited in its international acceptance to the U.S.A. and Canada only. Finally, RFID systems can include EAS (electronic article surveillance) capability similar in functionality to the sensormatic tag.

Major suppliers of RFID technology include Texas Instruments, Phillips, and Intermec. RFID has defied most attempts at standardization (13.56 MHz is in the standardization process). The goal from an industry development perspective is to create generic tags and interrogators that could be purchased from several vendors, thereby driving down costs. International standards would allow global companies the ability to reap the benefits of RFID. Several industry groups have tried to standardize RFID and efforts continue.

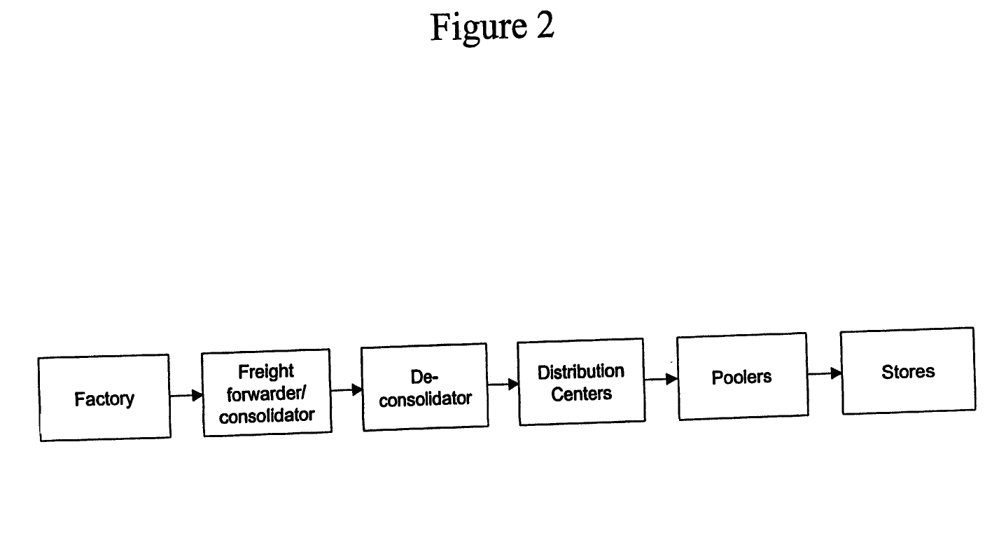

For purposes of this written description, the invention will be described in the context of a retail organization having a multiple-stage supply chain. In the example shown in FIG. 2, the supply chain includes factories for producing products, a freight forwarding/consolidator, a de-consolidator, distribution centers, poolers and stores or retail outlets. It will be appreciated by those skilled in the art that the present invention is applicable to retail organizations having different supply chains and also applicable to non-retail organizations.

The present invention relates to use of RFID technology that provides advantages in each stage of the supply chain of a retail organization. Again, the example of a supply chain is shown in connection with FIG. 2. For purposes of this description, it will be assumed that the RFID technology is employed in a retail organization that sells ready-to-wear garments and other items, keeping in mind that the present invention can be applied to any supply chain regardless of the kind of goods or services. In a preferred embodiment, an RFID tag is associated with each ready-to-wear garment or other item. The tag may be sewn into the garment and/or attached after the garment is manufactured.

In the first stage of the ready-to-wear retailer's supply chain, namely the factory, the RFID tag can be used to confirm the contents of cartons packed by the vendor at the unit level through non-line of sight scanning. RFID technology can also be used to match contents with shipping manifests and purchase orders. Again, the RFID tag could be any label or tag associated with the item. Examples include a hang tag, a price tag, a pocket flasher, packaging of all kinds, boxes, or a label sewn into the garment.

The use of the RFID technology in the factory as described above requires tag readers at the manufacturer sites and software that provides the ability to reconcile shipping information with the shipping manifest or purchase order, provide exception reporting and interfacing with a shipment tracking system.

Use of the RFID technology at the factory facilitates factory quality assurance processes and eliminates chargebacks by identifying actual quantities and variances up-front, prior to payment. Moreover, the use of the RFID technology in the factory provides distribution centers and others in the supply chain with accurate information about inbound units. This information can be used to help prevent loss from employee, contractor (shipper etc.) and/or customer theft. Moreover, for international shipments, the use of RFID technology can streamline customs processes through scanning of paperwork.

At the second stage of the ready-to-wear retailer supply chain, namely, the freight forwarder/consolidator stage, the RFID technology can be used to track goods received and shipped by the forwarder/consolidator at both the carton level and the unit level. This, of course, entails providing tag readers at forwarder/consolidator sites. Also, the system must be able to reconcile shipping information with shipping manifests/purchase orders and provide exception reporting interface with the shipment tracking system. Software is preferably provided for this purpose. Use of RFID technology at the freight forwarder/consolidator site in this way facilitates vendor audits, decreases unaccounted for inbound freight and streamlines customs paperwork. Thus, the invention is useful in loss prevention at this stage of the supply chain.

At the third stage of the ready-to-wear retailer supply chain, namely, the de-consolidator stage, the RFID technology can be used to track goods received and shipped by the de-consolidator. Again, this requires tag readers at the forwarder/consolidator sites and a system that includes software with the ability to reconcile shipping information with shipping manifests/purchase orders, provide exception reporting and interface with the shipment tracking system. Use of the RFID technology at the de-consolidator stage of the supply chain facilitates de-consolidator audits, decreases unaccounted for inbound freight, provides distribution centers with visibility to forthcoming receipts and improves the ability to sort by distribution center with accuracy. The invention also aids in loss prevention by ensuring that the product is accounted for throughout this stage.

The RFID technology has many applications in the distribution center (fourth) stage of the ready-to-wear retailer supply chain. To implement these applications and achieve the associated benefits, it is necessary to provide various tag readers (interrogators) at the distribution centers. For instance, tag readers should be provided at the distribution receiving docks. In accordance with another aspect of the present invention, tunnels with tag reading capability can be provided at the distribution center receiving docks. As used herein, “tunnel” is similar to a fixed location overhead scanner. In the preferred form the “tunnel” is a fixed reader shaped in the form of a tunnel that a carton would pass through so that the tags are read and identified as the carton passes through. The system should also include software for interfacing with a warehouse management system.

Use of the RFID technology at the distribution centers in this way provides numerous benefits, including eliminating labor required to manually input receipts; improving efficiency of the receiving process; facilitating freight claims; increasing throughput; eliminating sorting of cartons on the trailer; providing an ability to reconcile distribution center receipt data with bills of lading and forwarder/consolidator/de-consolidator data. The use of RFID at this stage also helps to prevent loss due to theft. In addition, the use of the RFID technology at the distribution center improves the value of information currently within a warehouse management system by making it available sooner.

In addition, the RFID technology can be used to write revised data to a unit level tag for special handling activities and to provide an ability to identify a unit as an alternative retail outlet product. In particular, by providing individual tags on each garment, the system can be used to write or alter pricing data on each tag. To make such a system practical, the tag reader should be able to write to multiple tags simultaneously by broadcasting information to be written. In the preferred embodiment, the tag reader can write to multiple tags simultaneously or write to individual tags without writing to adjacent tags. This greatly simplifies correction or markdown of prices and, thus, eliminates the labor required to manually correct each ticket. In addition, this system improves the efficiencies of the multifunction or special handling process and eliminates the manual re-ticketing process by writing cross-reference data to the ticket for an alternative retail store. Moreover, it is possible to electronically write multiple prices to reflect prices in different currencies on the tag for international shipments. Finally, use of RFID technology provides pre-receipt visibility to the distribution center, allowing the distribution center to forecast and plan labor requirements and anticipate special handling activities such as mixed cartons.

To implement this feature in a distribution center requires tag readers or tunnels equipped with tag readers in the distribution center multifunction area, as well as software interfaces with the overall inventory management systems.

Yet another advantage of using RFID technology at the distribution center stage of the supply chain is that RFID technology provides “visibility” to carton contents without opening the carton. Again, this requires tag readers or tunnels equipped with tag readers in the distribution center receiving and multifunction areas as well as software for interpreting the data read, and the interfacing with the scan and warehouse management systems. The benefit of such a system is that it reduces the labor associated with correcting incorrect contents and downstream activities.

In addition, if tag readers are provided for distribution center stocking and putaway associates (workers), the RFID system can also be used for replenishment carton verification. This results in reduced labor required for verification and reduces the amount of labor associated with wrong product content correction in stocking. The computer system should also interface with the warehouse management system.

In accordance with an important aspect of the present invention, the RFID technology can also be used at the distribution center stage of the supply chain to provide verification of pick selection. To accommodate this, the system should include tag readers and/or tunnels for manual pick and sorters and associated system enhancements. This arrangement involves automated sortation equipment, e.g, a tilt tray or the like, in which all orders for the allocation would be “batch picked,” placed on a “trough” type of container/belt to sorter induction, inducted directly onto trays and fixed read of units on trays. Again, “batch pick” refers to the picking of demand allocation for all stores within the same timeframe.

In addition, it is possible to write information directly onto the tag at the unit level. Readers can be provided in the chutes to verify contents and order completion or, alternatively, one fixed scan of carton contents through a tunnel can be used. In this way, the sortation and allocation of orders can be verified in a highly automated process. This arrangement provides numerous benefits, including eliminating inventory adjustments, increased accuracy and increased and improved utilization of capital. The system can also provide significant increases in productivity.

In the context of the distribution center stage of the supply chain, RFID technology can also be used to verify manual selection. In particular, by providing tag readers and/or tunnels for manual pick and sorters, hand-held or wearable units can be used to assist in manually picking or selecting units. The hand-held device reads the unit within the pick location (by pointing at the location/units) and systematically verifies that the user is in the right location and the product is the correct product. For example, the system emits an audio signal, such as a beep, to inform the user of the correct selection and indicates how many units to pick. The user pulls the units and then goes to the remaining locations to fulfill the store requirements. Upon pick completion, the carton is closed, sealed and sent on a conveyer through a tunnel or RFID tag reader to verify that the contents match the store requirements, thus guaranteeing 100% picking accuracy audits. Cartons with errors are recorded and diverted for correction, while others are routed to shipping. The benefits provided by this system include significant reduction, if not total elimination, of manual picking errors. Moreover, productivity can be increased by eliminating the requirement to read SKU data.

In addition, by providing distribution center associates with tag readers and making appropriate system enhancements, the RFID technology can be used in connection with inventory control and quality assurance. For instance, the RFID technology can be used to decrease time associated with cycle counts and inventory audits. Moreover, the use of RFID technology eliminates the need to open cartons to determine contents and count (this increases picker accuracy as mentioned). In addition, the system reduces labor associated with searching for a product (exception mode) and reduces labor associated with mixes and wrong content of cartons outside of receiving.

By providing tag readers, doorway portals, and tunnels equipped with tag readers at distribution center shipping docks, it is possible to track distribution center activity at the unit level. This eliminates the labor required to manually scan cartons, reduces misdiverts, and improves efficiency in the shipping process. Moreover, providing the tag readers and tunnels at distribution center shipping docks facilitates freight claims by providing visibility to the carton movement and contents. In connection with bill of lading applications, it is possible to print out a bill of lading with an RFID tag so that one scan of a tag at receipt would download the contents into the receiving system.

By providing tags and a yard antenna system, it is also possible to implement a yard management system using active tags and appropriate equipment. This, for example, could be used to identify when a truck is on premises, where it is parked and what inventory is on the truck. This system should be designed to interface with the ScaN and warehouse management (WMS and TMS) systems.

In one embodiment of the present invention, a portal dock loader 402, as shown in FIG. 4, is used as a tag reader. Portal Dock Loader 402 is preferably designed to work in conjunction with a Roller Table 404. Portal Dock Loader 402 includes a Sensing Portion 406 and a Stand Portion 408. Sensing Portion 406 preferably includes one or more RFID readers. These readers are preferably designed to interrogate RFID tags that pass proximate Sensing Portion 406.

Bins 410 containing merchandise or items that include RFID tags can be moved across Sensing Portion 406 by using the Rolling Table 404. This permits the items of merchandise contained within Bin 410 to pass within an appropriate distance that permits the RFID readers disposed in Sensing Portion 406 to interrogate the RFID tags associated with the merchandise Bin 410. The RFID readers and Sensing Portion 406 are in communication with a Computer 412. As the readers interrogate the RFID tags, information is transmitted to Computer 412. In this way, as merchandise is moved down a conventional Rolling Table 404, inaccurate assessment of the merchandise can be collected by Computer 412.

There are many uses for the Portable Dock Loader 402. Portable Dock Loader 402 can be used to verify that certain cartons have been placed within a trailer or have been shifted. Portable Dock Loader 402 can also be used at the receiving end to verify that certain shipping cartons, bins or merchandise have been received by the retail store or the next entity in the supply chain.

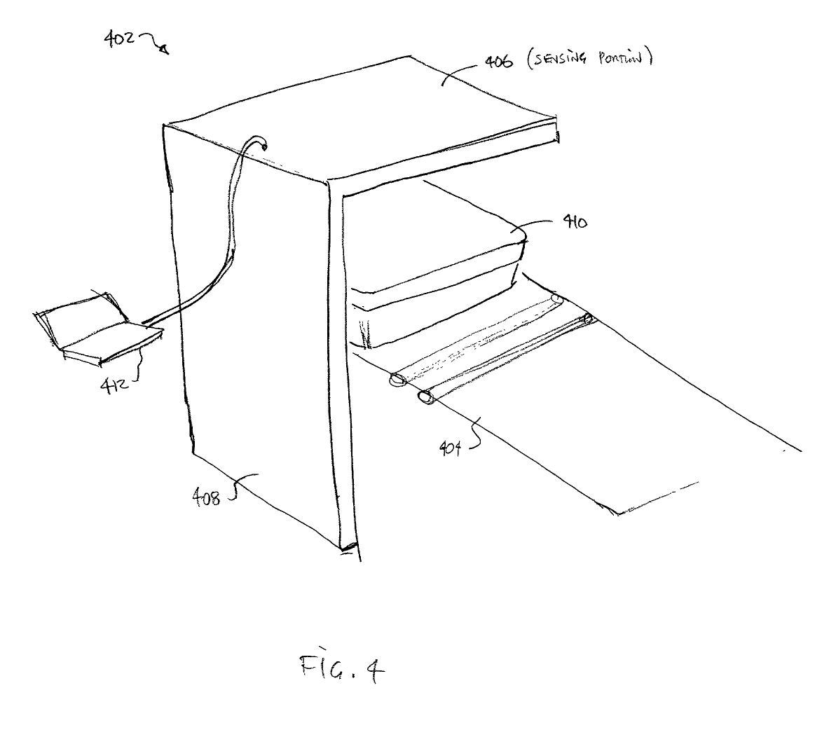

FIG. 5 shows another embodiment of the present invention. A conveyer belt 502 is used to move a Carton 504 during either loading or unloading. As Carton 504 passes within an appropriate distance of an RFID Reader 506, all of the RFID tags within the carton can be interrogated. The carton can also include a single unique ID to identify the carton. After the RFID information has been collected by Reader 506, the information can be transmitted to another Computer 508. Similar to the embodiment shown FIG. 4, this system can determine which items and cartons have been shipped, and if used at the receiving end, which items have been received. This system can also associate all of the items in the carton with the carton by using the carton's single unique identifier.

The RFID technology can also be used to track distribution center/catalogue and online return receipts at the unit level. This helps in tracking the product center finishers and restocking of products. To implement this procedure, the users at the distribution center return area should be provided with tag readers.

The RFID technology can also be used to increase distribution center security, time and attendance and labor activity reporting by providing RFID tags in associate (worker) identification badges, placing antennas at entrance and exit locations so as to account for human resources. Preferably, this system is interfaced with a warehouse management system. One of the principal advantages of extensive use of RFID technology at the distribution centers as discussed heretofore is reduced labor effort associated with products lost within the distribution center.

RFID technology can also be used at the third party distribution (pooler) stage of the ready-to-wear retailer supply chain. In particular, the RFID technology can be used to track pooler receipts at the unit level. This will support freight claims, decrease outbound lost freight, provide visibility to stores of forthcoming shipments, facilitate value added services ability and provide visibility to stores turning away product. To implement this system, it is necessary to provide RFID tag readers at the pooler sites and software at the pooler sites to interface data collected with inventory systems.

The present invention further contemplates wide use of RFID technology in retail stores, the final stage of the ready-to-wear retailer supply chain. To begin with, RFID technology can be used to track carton contents at each store upon receipt. To implement this, RFID tag readers should be provided at store receiving entrances. Providing this technology decreases the time and labor required to manually track store receipts, improves accuracy of inventory data by eliminating inaccuracies in the manual receipt process and enables assumed receipts for direct delivery shipments. To accommodate this, the data collection system interfaces with inventory systems via the management tracking system and the management tracking system reports discrepancies between bill of lading and products received.

A significant advantage of using ubiquitous RFID technology within the stores is the ability to perform perpetual inventory counts. This can be achieved by providing hand-held readers for inventory counts or providing readers imbedded in walls for automated inventory count. The data received from these RFID tag readers is interfaced with the store inventory system. This automated perpetual inventory count system improves accuracy of inventory data, decreases the time and labor required to manually scan individual garments and provides real-time visibility to product gaps (for example, sizes, colors and styles) on the sales floor that may be replenished immediately from store inventory.

Naturally, ubiquitous use of RFID technology within the store also assists in loss prevention and security. In this context, the RFID technology can replace existing systems such as sensor tag technology, and thereby eliminate the labor required to attach and detach the sensor tags and improve security at stores that do not have sensor tag capabilities. To implement this feature, tag readers should be provided at store exits and staff should be trained to remove or flag as sold tags after sale.

RFID technology offers the advantage of being able to store the identity of the person deactivating or flagging a tag. In this way, it is possible to reduce loss due to employee theft by tracing loses to individual employees. In contrast, sensor tags can be anonymously removed by anyone having access to the tag removal device.

Use of RFID technology associated with each unit, also makes it possible to read the contents of the customer's purchases at the point-of-sale to increase the accuracy of the checkout process, decrease time and labor required for checkout (cashier and wrapping activities) and decrease waiting time for the customer during checkout. To implement this feature of the present invention, tag readers should be provided at the checkout or cash/wrap station and the staff should be instructed in the removal and/or flagging of the tags as sold after sale. In addition, the data read should be interfaced with the point-of-sale system.

In accordance with another aspect of the present invention, RFID technology can be used to track assets at stores, distribution centers and other company facilities. In the context of a retail store, for example, RFID tags could be applied to assets, such as store fixtures, shelving, and the like. Small items such as hand held scanners or other equipment could also be tagged. By providing antennas (preferably fixed) throughout the facility, the assets that are tagged can be tracked for the purposes of planning, purchasing, management, and disposal. The use of RFID technology in this way provides systematic visibility of the assets as items are moved within stores, departments, cost centers, off-site storage, etc. Visibility would allow accountability and better management of assets resulting in accurate purchasing requirements, reduced on-hand quantities, and records to provide an accurate tax base. In the context of fixtures used in a retail store, the visibility provided by use of RFID technology could be used to ensure that fixtures are located in conformance with store policy.

FIG. 6 shows a preferred embodiment of the present invention. One example of a fixture used in a retail store is a shelving system 602. Shelving system 602 includes shelves 604 and 606 that are designed to hold merchandise. Preferably, an RFID reader is associated with shelving system 602 and in an exemplary embodiment, shown in FIG. 6, several RFID readers are disposed proximate different collections of merchandise. As shown in FIG. 6, a first reader 608 is disposed proximate a first collection of merchandise 610, a second reader 612 is disposed proximate a second collection of merchandise 614, a third reader 616 is disposed proximate a third collection of merchandise 618, and a fourth reader 620 is disposed proximate a fourth collection of merchandise 622. The readers 608, 612, 616 and 620 are preferably configured in a manner that permits them to interrogate and read their associated collections but not other collections.

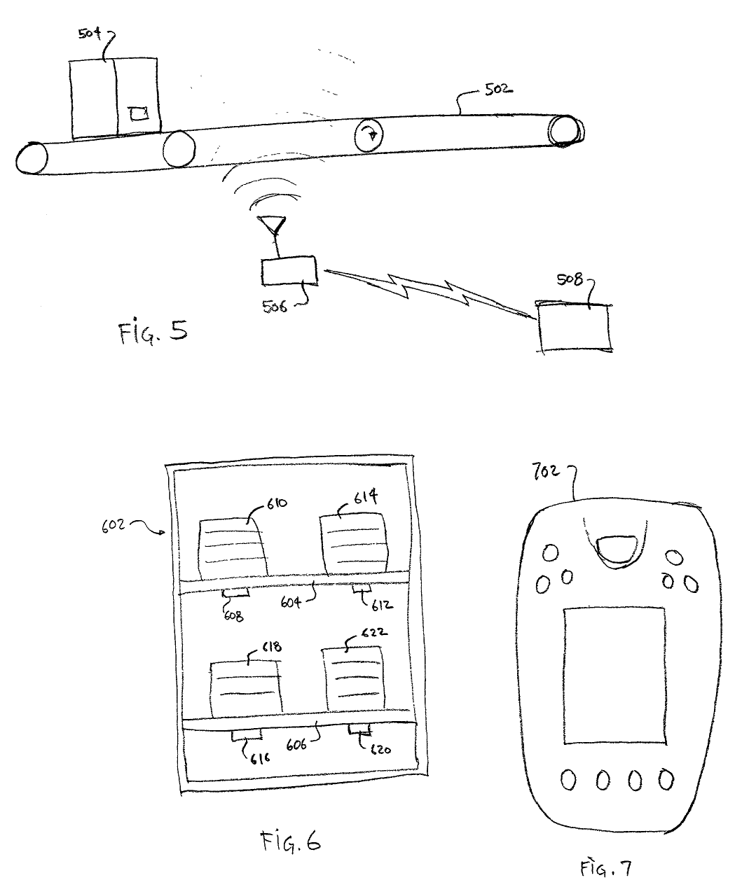

Once the preferred arrangement has been established, readers 608, 612, 616 and 620 may be placed in communication with a computer or may communicate with a wireless device 702 (see FIG. 7). Communication can occur between either of these devices and shelving system 602 using wire line or wireless communications systems.

Shelving system 602 can provide many different types of information. Because Readers 608, 612, 616 and 620 can either continuously or intermittently interrogate RFID tags associated with merchandise, Shelving System 602 can provide near real time or real time data related to merchandise disposed on Shelving System 602. Also because the various readers are associated physically with Shelf System 602 at particular locations, Shelf System 602 can also provide information related to where the merchandise is located within Shelf System 602. For example if the merchandise is categorized and placed on Shelving System 602 by size, users can determine if merchandise has been improperly filed or improperly located within Shelf System 602. The information can also be used to determine real time inventory tracking and to determine what items are available or not available on the retail floor.

Shelving system 602 can also be used with wireless device 702. Wireless device 702 can be used to collect inventory information. This inventory information can be used to determine which items are currently on the sales floor, which items need to be replenished with stock from a backroom, and which items need to be ordered from a distribution center. The system can also be used to assist customers. If a customer asks for a particular item, for example, by size and style, the characteristics of the item can be entered into wireless device 702. The salesperson can then use wireless device 702 to scan and interrogate RFID tags. When a tag matching the description of the item requested by the customer is found, wireless device 702 can provide an indication. Preferably, wireless device 702 returns an audible indication. Wireless device 702 can also return a series of informative beeps or any other audible tones as the salesperson approaches the requested item. The audible tones can increase in pitch or frequency to guide the salesperson to the requested item.

Similarly, RFID technology can be used to track samples of garments that a design, merchandising, production, or marketing division may use to plan for upcoming products. As discussed above, these samples or prototypes generally remain in-house, and the system can be used to track the location of those samples as well as in-house shipments of those samples. RFID tags could be applied to the samples to allow tracking of individual units as they are moved among various departments, divisions, and offices within the company. This would ensure accountability, controls, and proper use or disposal of the sample units.

Use of RFID technology at the store location also makes it possible to better control the return process by, for example, tracking reasons for returns back to the vendor factory level and therefore identify specific vendor factories producing garments with quality problems such as fit and other defects. In this way, the tags can be used to facilitate vendor performance tracking. Again, implementing the system requires tag readers at the cash/wrap (checkout) stations and a software interface with the point-of-sale system.

In accordance with another aspect of the present invention, RFID technology can be used to track the fitting room traffic. For this purpose, antennas would be placed at the entrance of fitting rooms to read the tags of garments that are brought into the fitting room. In this way, a retailer can gather information as to what products are taken to fitting rooms—an indication of consumer interest (at least initial interest) in some aspect (style, color appearance etc.) of the garment. The fitting room data collected can be correlated to sales data to provide valuable insight as to which of the products that are tried by consumers are ultimately purchased. There are numerous ways in which information obtained from fitting room data collected (and e.g., correlated to sales data) can be used for merchandising, planning and/or marketing decisions for that specific product. For example, the data might show that a particular style of garment is frequently tried on, but seldom purchased, which could suggest a problem with the fit or detailing of the garment. Alternatively, the relationship between the frequency with which a garment is tried on and the garment's location within the store could be helpful in merchandising products. In this way, this technology provides an in-house market research tool.

Another possible use is to implement customer loyalty program cards, gift cards, wish list cards and the like by providing customers with cards equipped with RFID tags. The system could even identify customers as they enter the store to improve customer service.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention. Also, the invention is applicable to all forms of products, not just apparel.

What is claimed is:

1. A system for determining inventory comprising:
a fixture including a first region and adapted to hold a first collection of merchandise, the first collection of merchandise comprising at least one item with an associated RFID tag;
a reader disposed on the fixture and proximate the collection of merchandise, and the reader adapted to interrogate the RFID tag and retrieve information related to the RFID tag.

2. The system according to claim 1, wherein the first collection of merchandise includes a second item with an associated RFID tag.

3. The system according to claim 1, wherein the fixture is adapted to hold a second collection of merchandise and wherein a second reader is disposed on the fixture and proximate the second collection of merchandise, and wherein the second reader is adapted to interrogate and read a second RFID tag associated with the second collection of merchandise.

4. The system according to claim 3, wherein the first reader is adapted to read the first collection of merchandise but is not adapted to read the second collection of merchandise.

5. The system according to claim 4, wherein the second reader is adapted to read the second collection of merchandise but is not adapted to read the first collection of merchandise.

6. The system according to claim 1, wherein the fixture is capable of sensing available inventory disposed on the fixture in near real time.

7. The system according to claim 1, wherein the fixture is capable of sensing whether the item is properly located on the fixture.

8. A method for determining inventory comprising the steps of:
(a) associating a first RFID tag with a first item of merchandise;
(b) placing the first item proximate a first location of a fixture;
(c) placing a first RFID reader proximate the first location of the fixture; and
(d) interrogating the RFID tag associated with the item with the reader.

9. The method according to claim 8, further comprising the step of associating a second RFID tag with a second item of merchandise and placing the second item proximate the first location.

10. The method according to claim 9, further comprising the step of associating a third RFID tag with a third item of merchandise and placing the third item proximate a second location of the fixture.

11. The method according to claim 10, wherein the first reader interrogates at least one RFID tag in the first location but does not interrogate the third RFID tag.

12. The method according to claim 10, wherein the first reader interrogates at least one RFID tag in the first location but does not interrogate the third RFID tag.

13. A method for obtaining inventory information comprising the steps of:
(a) associating a first RFID tag with a first item of merchandise;
(b) placing the first item proximate a first location of a fixture;
(c) placing a first RFID reader proximate the first location of the fixture;
(d) interrogating the RFID tag associated with the item with a wireless handheld device.

14. The method according to claim 13, wherein the wireless handheld device receives information related to an FRID tag.

15. The method according to claim 14, wherein the wireless handheld device interrogates RFID tags and determines if a particular RFID tag matches the information received.

16. The method according to claim 15, wherein the wireless handheld device responds with a signal if a particular RFID tag matches the information received.

17. The method according to claim 16, wherein the signal is audible.

18. The method according to claim 13, wherein the wireless handheld device can interrogate a plurality of RFID tags and collect information related to those tags in order to determine available inventory.

19. A system for using radio frequency identification (RFID) in a supply chain of a retail operation organization, the system comprising:
an RFID tag is associated with each item to be tracked;
a plurality of tag readers disposed at various locations throughout the supply chain;
at least one host computer for receiving and processing information from the tag readers and interfacing with a system used for at least one of inventory, operations and logistics.

20. The system according to claim 19, wherein the at least one host computer for receiving and processing information from the tag readers interfaces with a system used for inventory and a system used for logistics.

21. A method for using radio frequency identification (RFID) in retail operations, the method comprising the steps of:
associating an RFID tag with each item to be tracked;
placing a plurality of tag readers at locations throughout the supply chain; and
providing at least one host computer for receiving and processing information from the tag readers and interfacing with at least one of: inventory, operations and logistics systems.

22. The method according to claim 21, wherein the step of associating an RFID tag with each item to be tracked comprises step of sewing an RFID tag into a garment; and
wherein the method further comprises the step of storing vendor/manufacturer identification information in the RFID memory to enable the tracking of customer returns due to poor quality of merchandise produced by the vendor/manufacturer.

23. The method according to claim 21, further comprising the step of performing a statistical analysis of returns by vendor/manufacturer.

24. The method according to claim 21, further comprising the steps of: scanning the RFID tagged units before delivering to the poolers and during store delivery to determine discrepancies and provide the documentation to support freight claims whereby freight losses can be recouped.

25. The method according to claim 21, further comprising the steps of using RFID technology to scan RFID tagged goods in the storage when an item is not in stock on the sales floor, whereby the method is used to reduce lost sales due to merchandise not on the sales floor, comprising the steps of collecting and storing data concerning items in storage collection and storing data concerning items in stock on the sales floor and comparing the data to identify items that are in storage, but not in stock on the sales floor.

26. The method according to claim 21, further comprising using RFID technology to track fitting room traffic comprising the steps of placing antennas proximate an entrance of one or more fitting rooms to read RFID tags that are brought into the one or more fitting rooms; collecting data related to the identity of products taken into the one or more fitting rooms as an indicia of consumer interest.

27. The method according to claim 21, further comprising the step of correlating the fitting room data with other data, wherein the other data is sales data.

28. The method according to claim 21, further comprising the step of correlating the fitting room data with other data, wherein the other data is shelf location data.

29. The method according to claim 21, wherein the RFID tag is a read/write tag.

30. The method according to claim 21, comprising the steps of: providing hand held readers for inventory counts; receiving data received from the readers and interfacing the data with the store inventory system, whereby continuous inventory counts can be performed.

31. The method according to claim 21, comprising the steps of: providing readers proximate merchandise for automated inventory count; receiving data received from the readers and interfacing the data with the store inventory system, whereby continuous inventory counts can be performed.

32. The method for using radio frequency identification in retail operations according to claim 21, further comprising the step of comparing data identifying items on the sales floor to data identifying items that are in stock to determine items in stock that are not on display; and providing notice of such condition.
